(19) United States
(12) Patent Application Publication
(10) Pub. No.: US 2024/0089837 A1
(43) Pub. Date: Mar. 14, 2024

(54) CAPABILITY BASED CELL SELECTION AND CELL RESELECTION

(71) Applicant: QUALCOMM Incorporated, San Diego, CA (US)

(72) Inventors: Naeem AKL, Bridgewater, NJ (US); Navid ABEDINI, Basking Ridge, NJ (US); Xipeng ZHU, San Diego, CA (US)

(21) Appl. No.: 17/931,825

(22) Filed: Sep. 13, 2022

(51) Int. Cl. H04W 48/16; H04W 36/00

(52) U.S. Cl. CPC H04W 48/16; H04W 36/0085

(57) ABSTRACT

Certain aspects of the present disclosure provide techniques for capability based cell selection and cell reselection. A method for wireless communications by a user equipment (UE) includes receiving system information including information for cell selection, cell reselection, or a combination thereof. The system information comprises at least first system information associated with a first one or more capabilities and second system information associated with a second one or more capabilities. The method includes performing a measurement of one or more signals from one or more cells. The method includes performing cell selection, cell reselection, or both based at least in part on the system information, the measurement of the one or more signals, and one or more capabilities of the UE.

### BACKGROUND

### Field of the Disclosure

Aspects of the present disclosure relate to wireless communications, and more particularly, to techniques for cell selection and reselection.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication by a user equipment (UE). The method includes receiving system information including information for cell selection, cell reselection, or a combination thereof. The system information comprises at least first system information associated with a first one or more capabilities and second system information associated with a second one or more capabilities. The method includes performing a measurement of one or more signals from one or more cells. The method includes performing cell selection, cell reselection, or both based at least in part on the system information, the measurement of the one or more signals, and one or more capabilities of the UE.

Another aspect provides a method for wireless communication by a network entity. The method includes obtaining information indicating one or more capabilities including one or more capabilities of the network entity, one or more cell capabilities, one or more UE capabilities, or a combination thereof. The method includes outputting system information including information for cell selection, cell reselection, or a combination thereof. The system information is based at least in part on the one or more capabilities.

Other aspects provide: an apparatus operable, configured, or otherwise adapted to perform the aforementioned methods as well as those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts an example process flow for cell selection and cell reselection.

FIG. 6 depicts an example call flow for communications in a network between a network entity, a first UE, and a second UE.

FIG. 7 depicts an example method for wireless communications by a UE.

FIG. 8 depicts an example method for wireless communications by a network entity.

FIG. 9 depicts aspects of an example communications device.

FIG. 10 depicts aspects of an example communications device.

### DETAILED DESCRIPTION

Aspects of the present disclosure provide apparatuses, methods, processing systems, and computer-readable mediums for capability based cell selection and cell reselection.

In certain systems, the network provides system information configuring UEs for cell selection and cell reselection. In some aspects, the system information includes one or more parameters for determining whether a cell satisfies a cell selection/reselection criteria and one or more parameters for determining whether to perform cell selection/reselection measurements. The system information may include one or more offsets, one or more thresholds, and/or other parameters for the cell selection/reselection and for performing the cell selection/reselection cell measurement. Typically, the system information is agnostic to the UE capabilities. The UE and/or the network, however, may prefer certain cell selections/reselections depending on the capabilities of the UE and/or the network.

Aspects of the disclosure provide for capability-based cell selection and reselection. In some aspects, first system information is provided for UEs that support a first one or more capabilities and second system information is provided for UEs that support a second one or more capabilities. A second capability may include lack of support for a first capability. For example, the first system information may include first parameters for determining whether to perform cell reselection/reselection measurements and first parameters for performing cell selection and cell reselection, and the second system information may include second parameters for determining whether to perform cell reselection/reselection measurements and second parameters for performing cell selection and cell reselection. Accordingly, the UE can determine whether to use the first system information or the second system information for measurements and cell selection and reselection based on the capabilities of the UE and/or the capabilities of the cell or the base station. Accordingly, the cell selection and reselection can be configured and/or performed in a more flexible, dynamic, manner based on the capabilities of the network and/or the capabilities of the UE.

Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

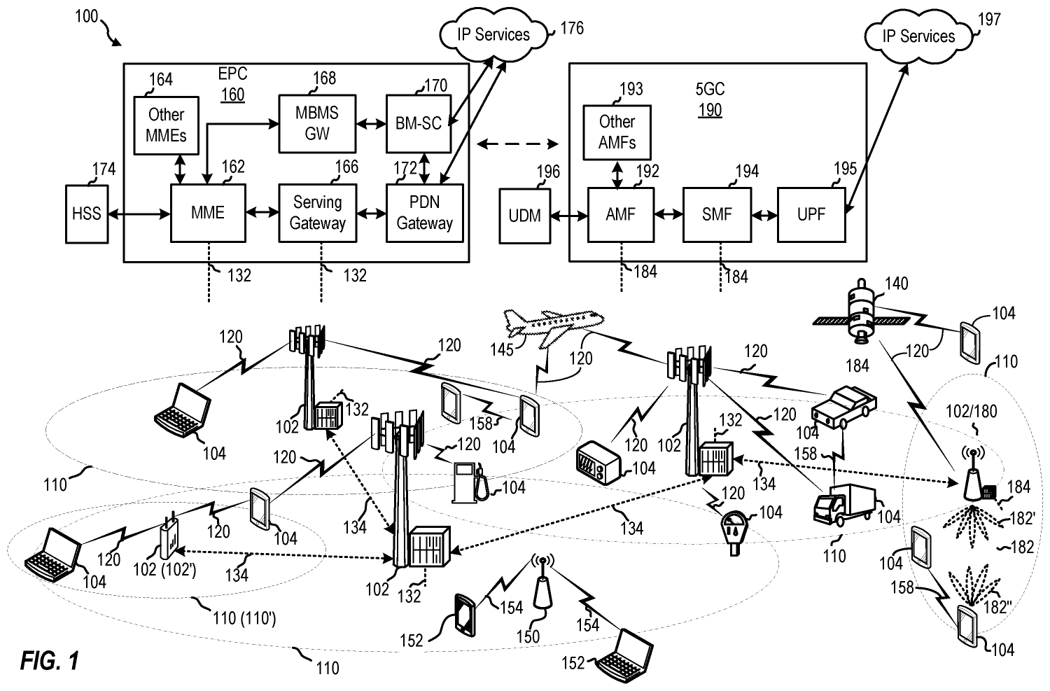

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

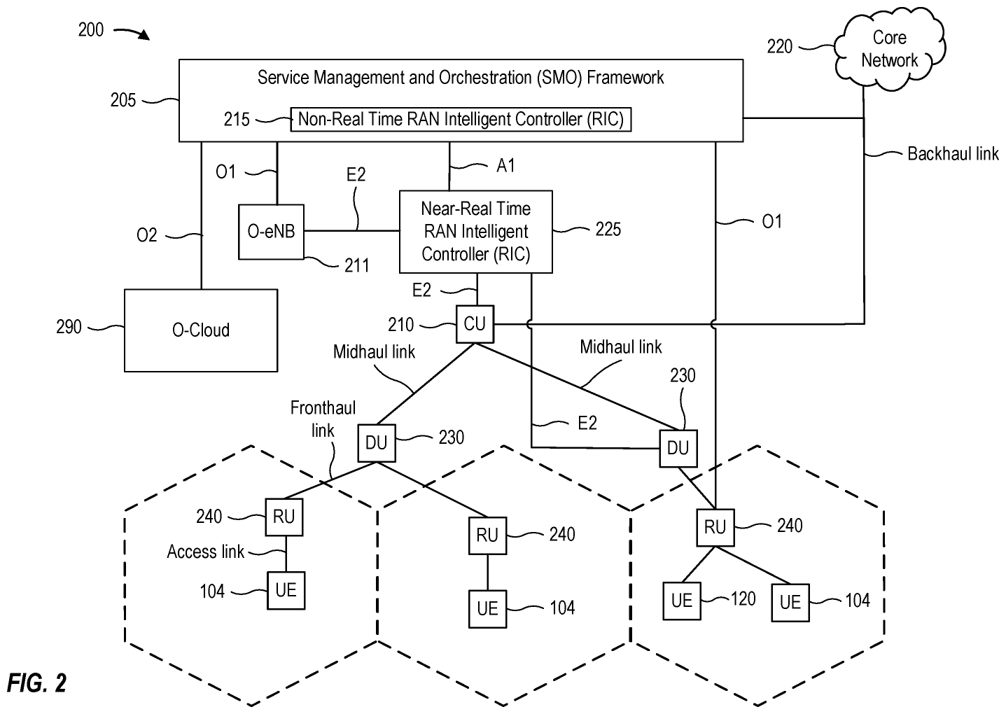

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (MC) 225 via an E2 link, or a Non-Real Time (Non-RT) MC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3r d Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT MC 215 or the Near-RT MC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

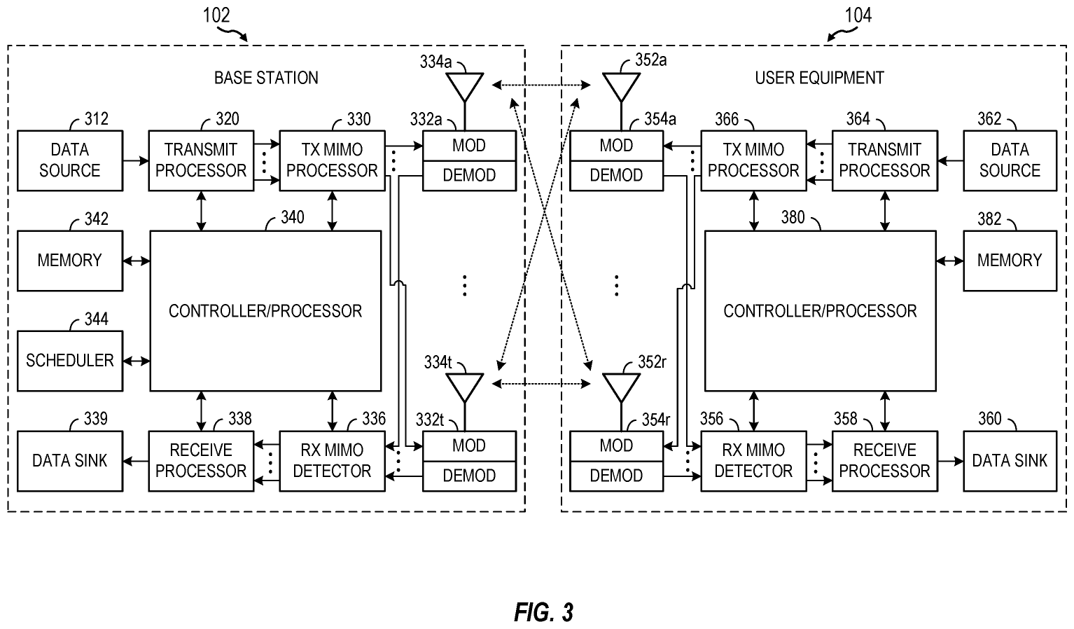

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

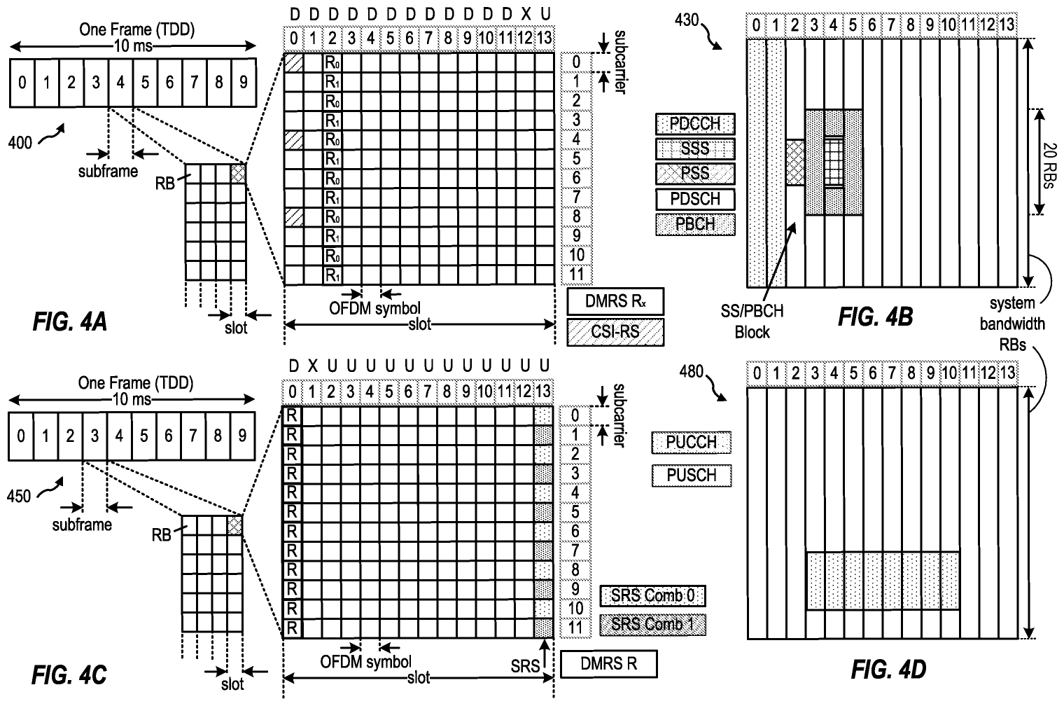

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

A UE that is searching for a cell to camp on performs cell selection to search for and select a cell to camp on. A UE that is already camped on a cell performs cell reselection to search for and select a new cell to camp on.

A UE in an RRC_IDLE state or an RRC INACTIVE state performs cell selection and reselection after selecting a public land mobile network (PLMN) or a standalone non-public network (SNPN).

With cell selection, the UE searches for a suitable cell of the selected PLMN or selected SNPN, chooses that cell to provide available services, and monitors its control channel. This procedure is defined as “camping on the cell.” The suitable cell may be a cell that satisfies a suitable cell criteria for a cell on which the UE may camp. One example of suitable cell criteria is defined in 3GPP TS 36.304 v17.1.0, clause 4.5.

After selecting the cell, the UE may perform a non-access stratum (NAS) registration procedure in the tracking area of the chosen cell to register the presence of the UE in the cell.

While camped on the cell, if the UE finds a more suitable cell, according to a cell reselection criteria, the UE reselects onto that cell and camps on it. If the new cell does not belong to at least one tracking area to which the UE is registered, the UE may perform another location registration is performed.

When the UE camps on a cell in the RRC_IDLE or the RRC_ANACTIVE state, the UE can receive system information from the PLMN or the SNPN, the UE can establish an RRC connection or resume a suspended RRC connection by initially accessing the network on the control channel of the cell on which it is camped. If the network needs to send a message or deliver data to the registered UE, the network can send a “paging” message for the UE on the control channels of all the cells in the corresponding set of areas. The UE will then receive the paging message and can respond. The UE may then transfer to an RRC CONNECTED mode.

One example of cell selection and reselection procedures is defined in 3GPP TS 36.304 v17.1.0, clause 5.2.

For initial cell selection (no prior configuration of which radio frequency (RF) channels are NR frequencies), the UE scans all RF channels in the NR bands according to its capabilities to find a suitable cell. On each frequency, the UE may only search for the strongest cell, except for operation with shared spectrum channel access where the UE may search for the next strongest cell(s).

The cell selection can expedited using stored information for several RATs. For example, the UE may store information of frequencies and cell parameters from previously received measurement control information elements or from previously detected cells.

Cell reservations or access restrictions can be imposed on one or more cells. The network can control the RAT(s) in which the cell selection should be performed, for instance by indicating RAT(s) associated with the selected PLMN, and by maintaining a list of forbidden registration area(s) and a list of equivalent PLMNs.

Once a suitable cell is found, the UE selects this cell. If no suitable cell is found, a different initial cell selection procedure may be started.

The cell selection criterion may be fulfilled when:

Srxlevl>0 AND

Squal>0, where

Srxlev=Qrxlevmeas−(Qrxlevmin+Qrxlevminoffset)−Pcompensation−Qoffsetₜₑₘₚ,

and

Squal=Qqualmeas−(Qualmin+Qualminoffset)−Qoffsetₜₑₘₚ

Srxlev is a cell selection signal reception (RX) level value, which may be in units of decibels (dB). Qrxlevmeas is a measured cell RX level value, such as a reference signal receive power (RSRP). Qrxlevmin is a minimum required RX level in the cell, which may be in units of dBms. A Qᵣₓₗₑᵥₘᵢₙ parameter may be received in system information (e.g., in a q-RxLevMinSUL IE, if the UE supports supplemental uplink (SUL) or in a q-RxLevMin IE). Qrxlevminoffset is an offset to the Qᵣₓₗₑᵥₘᵢₙ taken into account in the Srxlev evaluation as a result of a periodic search for a higher priority PLMN while camped normally. Pcompensation is an additional compensation offset. Pcompensation may be used for FR1, if UE supported by the UE. A Pcompensation parameter may be received in system information (e.g., in an additionalPmax parameter in an NR-NS-PmaxList IE). The Pcompensation may be:

max(P_{EMAX1}−P_{PowerClass},0)−(min(P_{EMAX2},P_{PowerClass})−min(P_{EMAX1},P_{PowerClass})) (dB), else max(P_{EMAX1}−P_{PowerClass},0) (dB), where

For FR2, Pcompensation is set to zero and, for an integrate access and backhaul (IAB) mobile termination (MT), Pcompensation is set to zero. P_{EMAX1} and P_{EMAX2} are a maximum signal transmission (TX) power level the UE may use when transmitting on the uplink in the cell. P_{EMAX1} and P_{EMAX2} can be received in system information (e.g. in a p-Max parameter in NR-NS-PmaxList IE). P_{PowerClass} is a maximum RF output power of the UE (dBm) according to the UE power class.

Squal is a cell selection quality value, which may be in units of dBs. Qqualmeas is measured cell quality value, such as a reference signal received quality (RSRQ). Qualmin is a minimum required quality level in the cell, which may be in units of dB. A Qualmin parameter may be received in system information. Qualminoffset is an offset to the Q_{qualmin} taken into account in the Squal evaluation as a result of a periodic search for a higher priority PLMN while camped normally.

Qoffsetₜₑₘₚ is an offset temporarily applied to a cell, which may be in in units of dBs. A Qoffsetₜₑₘₚ parameter may be signaled to a UE in system information.

Q_{rxlevminoffset} and Q_{qualminoffset} may only be applied when a cell is evaluated for cell selection as a result of a periodic search for a higher priority PLMN while camped normally in a VPLMN. During this periodic search for higher priority PLMN, the UE may check the criteria of a cell using parameter values stored from a different cell of this higher priority PLMN.

When camped on a cell, the UE regularly searches for a better cell according to the cell reselection criteria. If a better cell is found, that cell is selected. When evaluating Srxlev and Squal of non-serving cells for reselection evaluation purposes, the UE uses parameters provided by the serving cell and for the final check on cell selection criterion, the UE uses parameters provided by the target cell for cell reselection. Priorities between different frequencies or RATs for cell reselection may be provided to the UE by system information or dedicated signaling.

In some cases, the UE performs inter-frequency measurement when the serving cell fulfils one or more thresholds configured by system information. For example, measurement thresholds include: S_{IntraSearchP} which specifies the Srxlev threshold (in dB) for intra-frequency measurements; S_{IntraSearchQ} which specifies the Squal threshold (in dB) for intra-frequency measurements; S_{nonIntraSearchP} which specifies the Srxlev threshold (in dB) for NR inter-frequency and inter-RAT measurements; S_{nonIntraSearchQ} which specifies the Squal threshold (in dB) for NR inter-frequency and inter-RAT measurements; S_{SearchDeltaP} which specifies the threshold (in dB) on Srxlev variation for relaxed measurement; S_{SearchDeltaP-Stationary} which specifies the threshold (in dB) on Srxlev variation to evaluate stationary criterion for relaxed measurement; S_{SearchThresholdP} which specifies the Srxlev threshold (in dB) for relaxed measurement; S_{SearchThresholdP2} which specifies the Srxlev threshold (in dB) to evaluate not-at-cell-edge-criterion for relaxed measurement; S_{SearchThresholdQ} which specifies the Squal threshold (in dB) for relaxed measurement; and S_{SearchThresholdQ2} which specifies the Squal threshold (in dB) to evaluate not-at-cell-edge-criterion for relaxed measurement.

For transition to the UE to RRC_IDLE or RRC INACTIVE, the UE attempts to camp on a suitable cell. When returning to RRC_IDLE state after UE moved to RRC CONNECTED state from camped on any cell state, the UE attempts to camp on an acceptable cell. One example of acceptable cell criteria is defined in 3GPP TS 36.304 v17.1.0, clause 4.5. An RRC Release message from the network may indicate a redirectedCarrierInfo parameter with acceptable cell information. If the UE cannot find an acceptable cell, the UE is allowed to camp on any acceptable cell of the indicated RAT.

The RRC Release message may also include a cellReselectionPriorities parameter. If the RRC Release message does not include the cellReselectionPriorities parameter or a t320 timer expires, then the UE applies the cell reselection priority information broadcast in the system information.

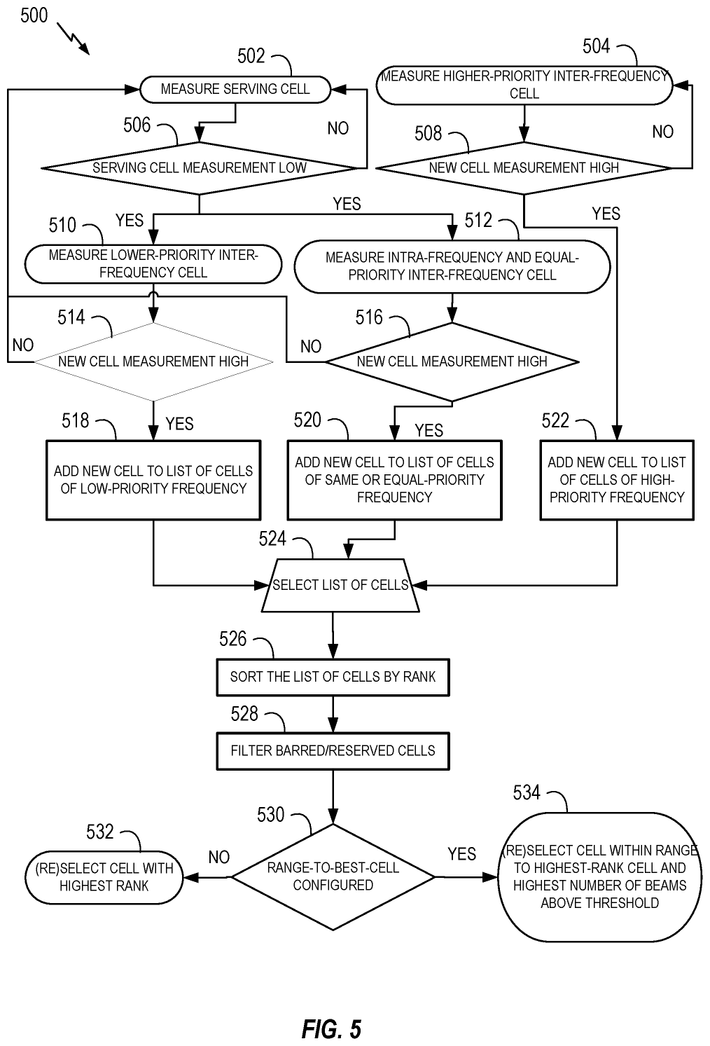

FIG. 5 is an example process flow 500 for cell selection and cell reselection. As shown in the process flow 500, at 502 the UE may measure a serving cell (e.g., perform a measurement of a signal received from the severing cell). If the serving cell measurement is not low (e.g., is at or above a threshold), at 506, the UE returns to 502 to measure the serving cell. If the serving cell measurement is low (e.g., is below the threshold), at 506, the UE measure a new lower-priority inter frequency cell at 510 and/or measures a new intra-frequency cell and/or a new equal-priority inter-frequency cell. If the new measurement is not high (e.g., below a threshold), at 514 or 516, then the UE returns to 502 to measure the serving cell. If the new lower-priority inter-frequency cell is high (e.g., at or above the threshold), at 514, then the UE adds the cell to a list of low-priority frequency cells at 518. If the new intra-frequency cell or equal priority inter-frequency cell is high (e.g., at or above the threshold), at 516, then the UE adds the cell to a list of low-priority frequency cells at 520.

At 504, the UE may measure one or more high-priority inter-frequency cells. If the high-priority cell is not high (e.g., is below a threshold), at 508, the UE returns to 504 to measure a higher-priority inter-frequency cell. If the high-priority cell is not high (e.g., at or above the threshold), at 508, the UE adds the cell to a list of higher-priority high-priority frequency cells at 522.

At 524, the UE selects one of the lists of cells (e.g., added to at 518, 520, 522). At 526, the UE sorts the list of cells by ranks. At 528, the UE filters the lists for barred/reserved cells (e.g., the barring/reservation indicated by system information). If a range-to best-cell is not configured, at 530, then the UE (re)selects the cell in the list with the highest rank at 532. If the range-to-best-cell is configured, at 534, then the UE (re)selects a highest rank cell from the list within the range and with a highest number of beams above a threshold.

A base station may prefer to serve on a first cell those UEs with a first UE capability, and potentially serve those UEs that do not have such a capability on a different cell. For example, a base station cell that supports BS-side full-duplex (FD) operation may prefer to serve UEs that are capable of reporting “worst” beams or that support CLI measurements, each of which is a UE capability. FD operation includes support for simultaneous uplink and downlink transmission on a carrier.

Similarly, a UE with a first UE capability may prefer to be served by a cell that supports serving UEs with the first UE capability. For example, a UE that supports UE-side FD operation capability may prefer to be served on a cell that schedules the UE with consideration to this capability to achieve higher UE throughput

Also, a base station cell that wants to perform network energy saving may prefer to serve UEs that can support dynamic activation/deactivation of type-2 configured grant PUSCH in order to dynamically adapt UL UE transmissions with energy-saving patterns on the base station cell. Type-2 configured grant can be RRC configured semi-persistent UL grants which may be activated by downlink control information (DCI) signaling.

A base station cell that wants to perform network energy saving may prefer to serve a UE that can dynamically report traffic predictions to the base station cell to reduce blind monitoring of the base station cell on pre-configured UL UE transmission occasions such as CG-PUSCH or scheduling requests.

The base station may implement energy saving on a cell, which may use different synchronization signal block (SSB) or common channel configuration, which may have an impact on certain legacy UEs. Such UEs impacted by the different SSB or common channel configuration should not camp on the cell. Energy saving cells may be included as a (legacy) neighbor cell in the system information block (SIB) of a normal cell. Otherwise, the legacy UE will search for the energy saving cell and waste power. On the other hand, UEs with an enhanced capability may be able to find the energy-saving cell.

As described above, the UE selects/reselects a cell based on cell selection/reselection parameters in system information, however, these parameters are agnostic to UE capability. Thus, a UE may camp on a cell and, upon performing initial access and reporting capability, the UE may have to be handed over to a different cell. This leads to additional latency and signaling overhead.

Further, using RedirectedCarrierInfo and/or cellReselectionPriorities in the RRC release message, the UE connects to the network and reports the UE capabilities. Upon transitioning back to the idle or inactive state, the network provides the UE with dedicated reselection parameters, which may be based on capabilities reported by the UE. However, these reselection parameters are only unicast and requires the UE to connect to the network first and report the UE capabilities.

In addition, using capability-related barring information in the SIB, an IAB-MT only (re-)selects a cell that broadcasts that it is IAB-supported in SIB 1. Also, “RedCap Broadcast Information” may indicate whether a cell allows or bars access to RedCap UEs with 1RX and 2RX branches. If barred, the cell is not a candidate for selection/reselection.

Accordingly, capability based cell selection and reselection may be provided to address the issues discussed above. For example, with capability-based cell selection and reselection, a base station that prefers to serve UEs that support a particular capability on a particular cell can configure such UEs with more lenient cell (re)selection criteria (e.g., via system information with cell selection parameters, priorities, and/or thresholds) for that cell and/or with stricter cell (re)selection criteria for selecting different cells. Similarly, a UE that prefers to be served by a cell that supports a particular capability may use, or be configured by the network to use, system information with more lenient cell (re)selection criteria for cells that support the capability and/or with stricter cell (re)selection criteria for cells that do not support the capability.

### Aspects Related to Capability Based Cell Selection and Cell Reselection

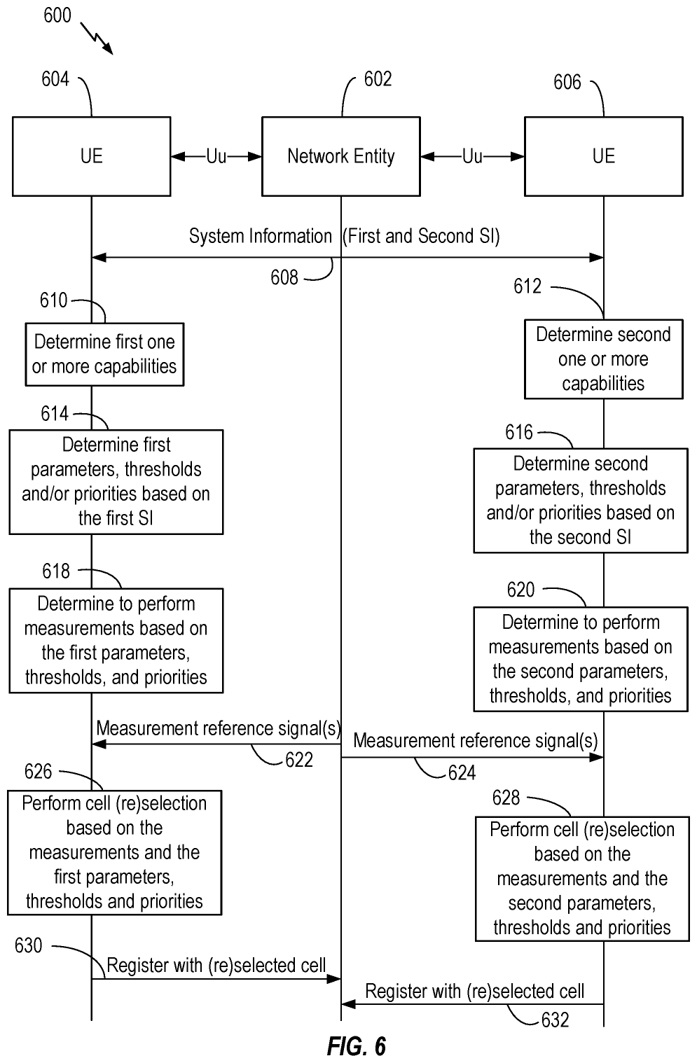

FIG. 6 depicts a process flow 600 for communications in a network between a network entity 602, a first UE 604, and a second UE 606. In some aspects, the network entity 602 may be an example of the BS 102 depicted and described with respect to FIGS. 1 and 3 or a disaggregated base station depicted and described with respect to FIG. 2. Similarly, the first UE 604 and the second UE 606 may be an example of UEs 104 depicted and described with respect to FIGS. 1 and 3. However, in other aspects, the first UE 604 and the second UE 606 may be another type of wireless communications device and network entity 602 may be another type of network entity or network node, such as those described herein. In some examples, the first UE 604 and/or the second UE 606 are in an RRC idle mode or an RRC inactive mode.

At 608, the network entity 602 provides system information to the first UE 604 and the second UE 606. In some examples, the network entity 602 broadcasts one or more SIBs to the first UE 604 and the second UE 606 including the system information. For example, the system information may be broadcast in any one or more SIB1, SIB2, SIB3, SIB4, SIB5, or a new SIB. In some examples, the system information is broadcast by the serving cell, a neighboring cell, or both. In some examples, the system information is group-common system information for a group of UEs. In some examples, the system information is provided in dedicated signaling to a single UE.

The system information includes first system information associated with a first one or more capabilities and second system information associated with a second one or more capabilities.

The first system information may include first parameters for determining whether to perform cell selection and cell reselection measurements and first parameters for performing the cell selection and cell reselection. The second system information may include second parameters for determining whether to perform cell selection and cell reselection measurements and second parameters for performing the cell selection and cell reselection.

In some examples, the system information includes a first threshold of a measurement of a cell for determining to perform cell selection and/or cell reselection measurements of the cell or cell frequency, the first threshold associated with a first one or more capabilities, and a second threshold of a measurement of a cell for determining to perform cell selection and/or cell reselection measurements of the cell or cell frequency, the second threshold associated with a second one or more capabilities.

In some examples, the system information includes a first threshold of a measurement of a cell for determining to perform cell selection and/or cell reselection measurements of the cell or cell frequency, the first threshold associated with a first one or more capabilities, and an offset of the first threshold, the offset associated with a second one or more capabilities.

In some examples, the system information includes a first threshold of a measurement of a cell for determining to perform cell selection and/or cell reselection measurements of the cell or frequency, the first threshold associated with a first one or more capabilities, and a scaling factor to the first threshold, the scaling factor associated with a second one or more capabilities.

In some examples, the system information includes a first threshold of a measurement of a cell for (re)selecting the cell, the first threshold associated with a first one or more capabilities, and a second threshold of a measurement of a cell for (re)selecting the cell, the second threshold associated with a second one or more capabilities.

In some examples, the system information includes a first threshold of a measurement of a cell for (re)selecting the cell, the first threshold associated with a first one or more capabilities, and an offset of the first threshold, the offset associated with a second one or more capabilities.

In some examples, the system information includes a first threshold of a measurement of a cell for (re)selecting the cell, the first threshold associated with a first one or more capabilities, and a scaling factor to the first threshold the scaling associated with a second one or more capabilities.

In some examples, the system information includes a first one or more priorities for (re)selecting one or more cells, the first one or more priorities associated with a first one or more capabilities, and a second one or more priorities for (re)selecting the one or more cells, the second one or more priorities associated with a second one or more capabilities.

In some examples, the system information includes a first time period for validity of a condition to measure and/or (re)selecting one or more cells or cell frequencies, the first time period associated with a first one or more capabilities, and a second time period for validity of the condition to measure and/or (re)selecting the one or more cells or cell frequencies, the second time period associated with a second one or more capabilities.

In some examples, the system information includes both capability based system information and capability agnostic system information for the cell measurement and/or cell selection and reselection.

Network energy saving states of cell may be exchanged between network entities. For example, network energy saving state information of the cell may be exchanged between gNBs, CUs, DU, and/or operations, administration, and maintenance (OAM) processes and functions. In some examples, a cell may be in one of several network energy saving states. In a “normal active” network energy saving state, any UE can access the cell. In a “power saving” network energy saving state, the cell may be less preferred for UEs requiring high performance. In a “deep power saving” network energy saving state, in which the cell may transmit reduced SSBs, a normal UE should not camp on the cell. In an “inactive” network energy saving state, a cell can be triggered by a wake-up signal from a UE that wants to camp on the cell. A legacy UE in a deep power saving or inactive cell may handed over to a new neighbor list (e.g., in SIB3 or SIB4). In some examples, network energy saving states of the cells may be provided to the UEs in system information, and the UE can use the network energy saving state information of the cell in the cell selection and reselection further based on the UE capabilities.

In some examples, the first system information includes first cell barring information associated with first one or more capabilities and second system information includes second cell barring information associated with second one or more capabilities. The first cell barring information may indicate one or more cells as unavailable for cell selection and cell reselection and the second cell barring information may indicate the one or more cells as available for cell selection and cell reselection.

In some examples, the first system information includes cell whitelisting information of one or more cells, the cell whitelisting information associated with first one or more capabilities, and second system information includes blacklisting information of the one or more cells, the blacklisting information associated with second one or more capabilities. The whitelisted cells indicate cells for performing measurements for cell selection and reselection. The blacklisted cells indicate cells to skip for performing measurements for cell selection and reselection.

Accordingly, the UEs may use the first system information or the second system based on the capabilities of the UE, the cell, or the network entity. For example, as shown in FIG. 6, at 610, the first UE 604 determines a first one or more capabilities.

The first one or more capabilities may include capabilities of the UE, capabilities of the network entity, and/or capabilities of one or more cells. The first one or more capabilities may include capabilities associated with a first feature set and the second one or more capabilities may include capabilities associated with a second feature set. In some examples, the second one or more capabilities may be lack of support for the first one or more capabilities.

The capabilities may include FD capability of the network entity and/or the UEs. The capabilities may include a capability of a UE to report “worst” beam. The capabilities may include a capability of a UE to perform DLI measurements. The capabilities of the network entity and/or of one or more cells to schedule UEs accounting for a UE capability for FD operation. The capabilities may include a capability of a UE to support dynamic activation/deactivation of type-2 configured grants. The capabilities may include a capability of a UE to dynamically report traffic predictions to the network entity to support network energy savings. The capabilities may include an enhanced capability of a UE to support a non-legacy SSB or common channel configuration for network energy savings. The capabilities may include a reduced capability of a RedCap UE. The capabilities may include an IAB MT capability of the UEs.

At 614, based on determining the first one or more capabilities, the first UE 604 determines first parameters, thresholds, and/or priorities for performing cell selection/reselection measurements and/or for performing the cell selection and/or reselection using the first system information.

In some examples, the first parameters, thresholds, and/or priorities determined from the first system information, at 614, includes one or more of: a first Srxlev threshold, a first Squal threshold, a first Qrxlevmin; a first Qrxlevminoffset; a first Pcompensation; a first Qualmin; a first Qualminoffset; a first Qoffsetₜₑₘₚ; a first S_{IntraSearchP}; a first S_{IntraSearchQ}; a first S_{nonIntraSearchP}; a first S_{nonIntraSearchQ}; a first S_{SearchDeltaP}; a first S_{SearchDeltaP-Stationary}; a first S_{SearchThresholdP}; a first S_{SearchThresholdP2}; S_{SearchThresholdQ}; and/or a first S_{SearchThresholdQ2}.

On the other hand, at 612, the second UE 606 determines a second one or more capabilities. The second one or more capabilities may include any different set of capabilities than the first one or more capabilities. In some examples, the second one or more capabilities includes lack of support for one or more of the first one or more capabilities.

At 616, based on determining the second one or more capabilities, he second UE 606 determines second parameters, thresholds, and/or priorities for performing cell selection/reselection measurements and/or for performing the cell selection and/or reselection using the second system information.

In some examples, the second parameters, thresholds, and/priorities determined from the second system information, at 616, includes one or more of: a second Srxlev threshold, a second Squal threshold, a second Qrxlevmin; a second Qrxlevminoffset; a second Pcompensation; a second Qualmin; a second Qualminoffset; a second Qoffsetₜₑₘₚ; a second S_{IntraSearchP}; a second S_{IntraSearchQ}; a second S_{nonIntraSearchP}; a second S_{nonIntraSearchQ}; a second S_{SearchDeltaP}; a second S_{SearchDeltaP-Stationary}; a second S_{SearchThresholdP}; a second S_{SearchThresholdP2}; S_{SearchThresholdQ}; and/or a second S_{SearchThresholdQ2}.

At 618, the first UE 604 determines to perform cell selection/reselection measurements based on the first parameters, thresholds, and/or priorities. At 620, the second UE 606 determines to perform cell selection/reselection measurements based on the first parameters, thresholds, and/or priorities.

Accordingly, the first UE 604 and the second UE 606 can receive and measure one or more measurement reference signals (MRSs) from the network entity 602, at 622 and 624, respectively. It should be understood that while cell selection with the network entity 602 is shown in FIG. 6, the UEs may perform measurements of signals from different network entities and can perform cell selection and reselection with the different network entities. Further, it should be understood that the UEs can perform measurements of the same or different cell and/or network entities, can perform measurements of the same or different MRSs, and can perform measurements at the same time or at different times.

At 626, the first UE 604 performs cell selection and/or cell reselection based on the measurements (performed at 622) and the first parameters, thresholds, and/or priorities (determined at 614) from the first system information based on the first one or more capabilities. For example, referring back to FIG. 5, the first UE 604 may perform measurements of cells (e.g., at 502, 504, 510, and 512). In some examples, the first UE 604 performs cell measurements based on a threshold measurements of the serving cell. In some cases, the threshold for measuring the cells based on the measurement of the serving cell is provided in the first system information which the UE uses based on the determining the first one or more capabilities. Further, as described above, for the evaluation of the cell measurements (e.g., at 506, 508, 514, 516), the cell selection criterion may be fulfilled when Srxlevl>0 and Squal>0, where the parameters of Srxlev and Squal are configured in the first system information used by first UE 604 based on determining the first one or more capabilities. Accordingly, the cell selection and reselection performed by the first UE 604, at 626, is based on the parameters and thresholds configured in the first system information, received by the first UE 604 at 608, which the first UE 604 uses based on the first UE 604 determining the first one or more capabilities at 610.

At 628, the second UE 606 performs cell selection and/or cell reselection based on the measurements (performed at 624) and the second parameters, thresholds, and/or priorities (determined at 616) from the second system information based on the second one or more capabilities. The cell selection and reselection performed by the second UE 606, at 628, is based on different thresholds and parameters than those used by the first UE 604 and that are configured in the second system information, received by the second UE 606 at 608, which the second UE 606 uses based on the second UE 606 determining the second one or more capabilities at 612.

In some examples, the first UE 604 and the second UE 606 may register at 630 and 632, respectively, with a respective (re)selected cell based on the cell (re)selection.

In some examples, the cell selection at 626 and 628 may performed as described above with respect to FIG. 5. As described above, the cell selection may include evaluating whether Srxlevl>0 and Squal>0 based on the determined parameters, thresholds, and/or priorities.

According to certain aspects (not shown), the network entity 602 may exchange the capability-dependent system information with another network entity (e.g., with another gNB or CU). For example, the network entity 602 may exchange the capability-dependent system information via an F1 or Xn interface with the other network entity. As part of the exchange, the network entity 602 may receive capability-dependent system information from the other network entity. In some examples, the capability-dependent system information is exchanged as part of served cell information. In some examples, the exchanged capability-dependent system information is considered during target cell selection during a handover procedure.

It should be understood that while two UEs and two different system information for two different one or more capabilities are discussed above with respect to FIG. 6, that any number of different system information may be provided by the network entity 602 for any number of different capabilities or combinations of capabilities.

### Example Operations of a User Equipment

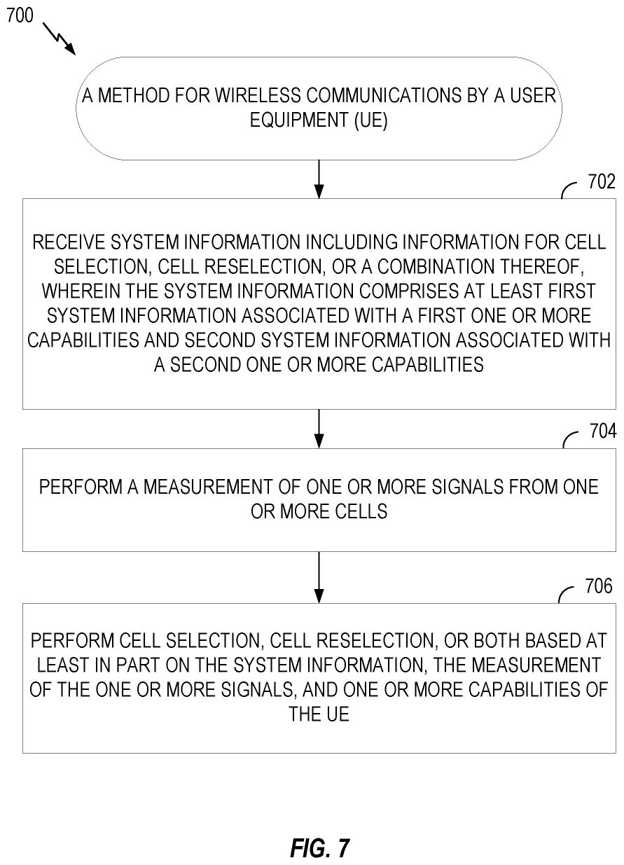

FIG. 7 shows a method 700 for wireless communications by a UE, such as UE 104 of FIGS. 1 and 3.

In one aspect, the UE is in a RRC idle mode or an RRC inactive mode.

Method 700 begins at 702 with receiving system information including information for cell selection, cell reselection, or a combination thereof. The system information includes at least first system information associated with a first one or more capabilities and second system information associated with a second one or more capabilities.

In one aspect, the system information is received in one or more SIBs.

In one aspect, the first one or more capabilities includes a first plurality of capabilities corresponding to a first feature group and the second one or more capabilities includes a second plurality of capabilities corresponding to a second feature group.

In one aspect, the second one or more capabilities are different than the first one or more capabilities. In one aspect, the second one or more capabilities comprises lack of support for the first one or more capabilities.

In one aspect, the one or more capabilities comprises an IAB MT capability of the UE or a RedCap capability of the UE.

In one aspect, the system information includes one or more thresholds for cell selection, one or more threshold for reselection, one or more thresholds for performing inter-cell measurements, or a combination thereof.

In one aspect, the system information includes one or more offsets associated with the one or more thresholds for cell selection, the one or more thresholds for reselection, the one or more thresholds for performing inter-cell measurements, or a combination thereof, based on the one or more capabilities.

In one aspect, the system information includes one or more threshold scaling factors associated with the one or more thresholds for cell selection, one or more thresholds for reselection, one or more thresholds for performing inter-cell measurements, or a combination thereof, based on the one or more capabilities.

In one aspect, the system information includes one or more time duration thresholds associated with the one or more thresholds for cell selection, one or more thresholds for reselection, one or more thresholds for performing inter-cell measurements, or a combination thereof, based on the one or more capabilities.

In one aspect, the one or more thresholds for cell selection include a cell selection received signal quality threshold (Srxlev) and a cell selection quality value (Squal).

In one aspect, the system information further includes a first set of parameters comprising first one or more minimum received quality level parameters, one or more minimum received quality offset parameters, one or more power compensation parameters, one or more signal quality temporary offset parameters, one or more signal quality minimum parameters, one or more cell specific signal quality minimum offset parameters, or a combination thereof, associated with the first one or more capabilities; and a second set of parameters comprising second one or more minimum received quality level parameters, one or more minimum received quality offset parameters, one or more power compensation parameters, one or more signal quality temporary offset parameters, one or more signal quality minimum parameters, one or more cell specific signal quality minimum offset parameters, or a combination thereof, associated with the second one or more capabilities.

In one aspect, the system information further includes cell barring information based on the one or more capabilities. The cell barring information indicates one or more cells as unavailable for cell selection and cell reselection, one or more cells as available for cell selection and cell reselection, or a combination thereof.

In one aspect, the one or more capabilities includes a capability of the UE to report one or more worst beams, a capability of the UE to perform CLI measurement, a capability of the UE for FD communication, a capability of the UE to dynamically activate and deactivate uplink transmissions with energy saving patterns, a capability of the UE to report traffic predictions, or a combination thereof.

In one aspect, the cell capability information comprises network energy saving state information.

In one aspect, the network energy saving state information indicates at least one of: a normal active state in which any UE is permitted to access the cell; a power saving state in which the cell is not preferred for high performance UEs; a deep power saving state in which a normal UE should not attempt to camp on the cell; or an inactive state in which the cell is not available for access until the cell wakes up.

In one aspect, the system information further indicates one or more whitelisted cells, one or more blacklisted cells, or a combination thereof, based on the one or more capabilities. The whitelisted cells indicate cells for performing measurements and the blacklisted cells indicate to skip for performing measurements.

Method 700 then proceeds to step 704 with performing a measurement of one or more signals from one or more cells.

Method 700 then proceeds to step 706 with performing cell selection, cell reselection, or both based at least in part on the system information, the measurement of the one or more signals, and one or more capabilities of the UE.

In one aspect, performing the cell selection, cell reselection, or both, at 706, includes prioritizing selection of a cell that supports one or more of the capabilities of the UE over a cell that does not support the one or more capabilities of the UE.

In one aspect, performing the cell selection, cell reselection, or both, at 706, includes performing the cell selection, the cell reselection, or both using the first system information when the UE supports the first one or more capabilities; and performing the cell selection, the cell reselection, or both using the second system information when the UE supports the second one or more capabilities.

In one aspect, the system information includes cell capability information of the one or more cells and performing the cell selection, cell reselection, or both, at 706, includes performing the cell selection, the cell reselection, or both based on the cell capability information.

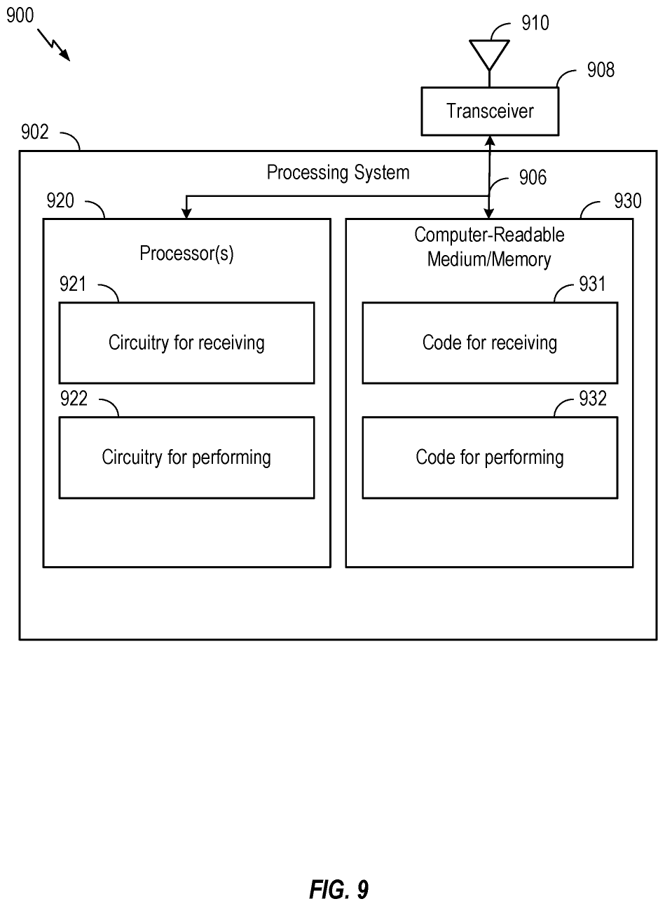

In one aspect, method 700, or any aspect related to it, may be performed by an apparatus, such as communications device 900 of FIG. 9, which includes various components operable, configured, or adapted to perform the method 700.

Communications device 900 is described below in further detail.

Note that FIG. 7 is just one example of a method, and other methods including fewer, additional, or alternative steps are possible consistent with this disclosure.

### Example Operations of a Network Entity

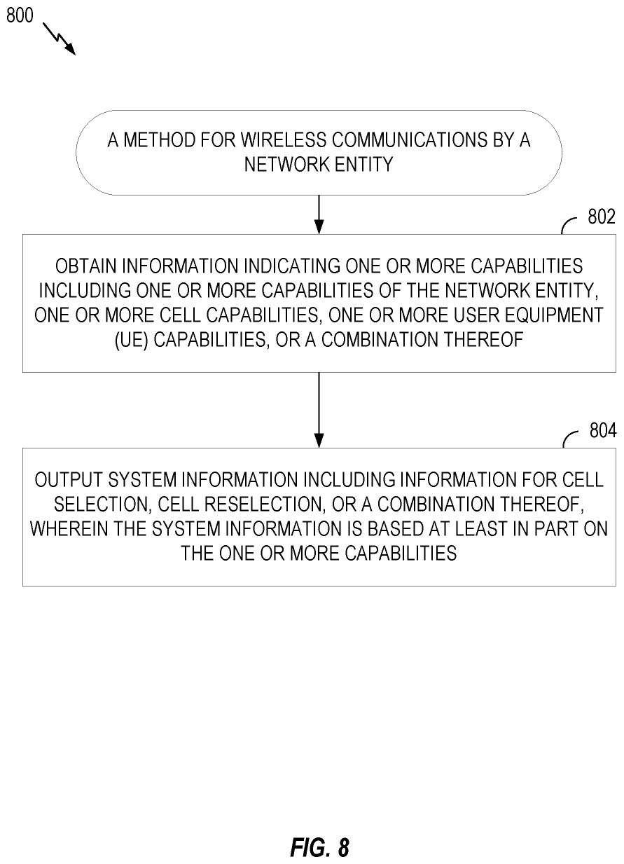

FIG. 8 shows a method 800 for wireless communications by a network entity, such as B S 102 of FIGS. 1 and 3, or a disaggregated base station as discussed with respect to FIG. 2.

Method 800 begins at 802 with obtaining information indicating one or more capabilities including one or more capabilities of the network entity, one or more cell capabilities, one or more UE capabilities, or a combination thereof.

Method 800 then proceeds to step 804 with outputting system information including information for cell selection, cell reselection, or a combination thereof. The system information is based at least in part on the one or more capabilities

In one aspect, the system information is output for transmission in one or more SIBs.

In one aspect, the system information comprises first system information for first one or more capabilities and second system information for second one or more capabilities. The second one or more capabilities are different than the first one or more capabilities.

In one aspect, the second one or more capabilities comprises lack of support for the first one or more capabilities.

In one aspect, the system information includes one or more thresholds for cell selection, one or more threshold for reselection, one or more thresholds for performing inter-cell measurements, or a combination thereof.

In one aspect, the system information includes one or more offsets associated with the one or more thresholds for cell selection, the one or more thresholds for reselection, the one or more thresholds for performing inter-cell measurements, or a combination thereof, based on the one or more capabilities.

In one aspect, the system information includes one or more threshold scaling factors associated with the one or more thresholds for cell selection, one or more thresholds for reselection, one or more thresholds for performing inter-cell measurements, or a combination thereof, based on the one or more capabilities.

In one aspect, the system information further includes one or more time duration thresholds associated with the one or more thresholds for cell selection, one or more thresholds for reselection, one or more thresholds for performing inter-cell measurements, or a combination thereof, based on the one or more capabilities.

In one aspect, the one or more thresholds for cell selection includes a cell selection received signal quality threshold (Srxlev) and a cell selection quality value (Squal).

In one aspect, the system information includes a first set of parameters comprising first one or more minimum received quality level parameters, one or more minimum received quality offset parameters, one or more power compensation parameters, one or more signal quality temporary offset parameters, one or more signal quality minimum parameters, one or more cell specific signal quality minimum offset parameters, or a combination thereof, associated with the first one or more capabilities; and a second set of parameters comprising second one or more minimum received quality level parameters, one or more minimum received quality offset parameters, one or more power compensation parameters, one or more signal quality temporary offset parameters, one or more signal quality minimum parameters, one or more cell specific signal quality minimum offset parameters, or a combination thereof, associated with the second one or more capabilities.

In one aspect, the first one or more capabilities comprises a first plurality of capabilities corresponding to a first feature group and the second one or more capabilities comprises a second plurality of capabilities corresponding to a second feature group.

In one aspect, the system information further includes cell barring information based on the one or more capabilities and the cell barring information indicates one or more cells as unavailable for cell selection and cell reselection, one or more cells as available for cell selection and cell reselection, or a combination thereof.

In one aspect, the one or more capabilities comprises an IAB MT capability or a RedCap.

In one aspect, the one or more capabilities comprises a capability to report one or more worst beams, a capability to perform CLI measurement, a capability for FD communication, a capability to dynamically activate and deactivate uplink transmissions with energy saving patterns, a capability to report traffic predictions, or a combination thereof.

In one aspect, the system information includes cell capability information of the one or more cells.

In one aspect, the cell capability information comprises network energy saving state information.

In one aspect, the network energy saving state information indicates at least one of: a normal active state in which any UE is permitted to access the cell; a power saving state in which the cell is not preferred for high performance UEs; a deep power saving state in which a normal UE should not attempt to camp on the cell; or an inactive state in which the cell is not available for access until the cell wakes up.

In one aspect, the system information further indicates one or more whitelisted cells, one or more blacklisted cells, or a combination thereof, based on the one or more capabilities: the whitelisted cells indicate cells for performing measurements; and the blacklisted cells indicate to skip for performing measurements.

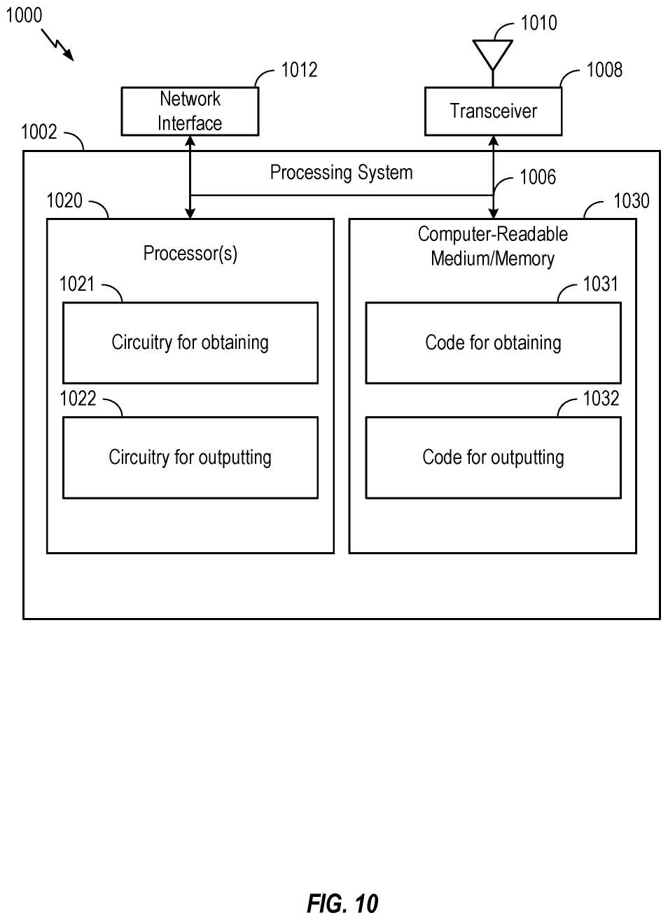

In one aspect, method 800, or any aspect related to it, may be performed by an apparatus, such as communications device 1000 of FIG. 10, which includes various components operable, configured, or adapted to perform the method 800.

Communications device 1000 is described below in further detail.

Note that FIG. 8 is just one example of a method, and other methods including fewer, additional, or alternative steps are possible consistent with this disclosure.

### Example Communications Devices

FIG. 9 depicts aspects of an example communications device 900. In some aspects, communications device 900 is a user equipment, such as UE 104 described above with respect to FIGS. 1 and 3.

The communications device 900 includes a processing system 902 coupled to a transceiver 908 (e.g., a transmitter and/or a receiver). The transceiver 908 is configured to transmit and receive signals for the communications device 900 via an antenna 910, such as the various signals as described herein. The processing system 902 may be configured to perform processing functions for the communications device 900, including processing signals received and/or to be transmitted by the communications device 900.

The processing system 902 includes one or more processors 920. In various aspects, the one or more processors 920 may be representative of one or more of receive processor 358, transmit processor 364, TX MIMO processor 366, and/or controller/processor 380, as described with respect to FIG. 3. The one or more processors 920 are coupled to a computer-readable medium/memory 930 via a bus 906. In certain aspects, the computer-readable medium/memory 930 is configured to store instructions (e.g., computer-executable code) that when executed by the one or more processors 920, cause the one or more processors 920 to perform the method 700 described with respect to FIG. 7, or any aspect related to it. Note that reference to a processor performing a function of communications device 900 may include one or more processors performing that function of communications device 900.

In the depicted example, computer-readable medium/memory 930 stores code (e.g., executable instructions) for receiving 931 and code for performing 932. Processing of the code 931-932 may cause the communications device 900 to perform the method 700 described with respect to FIG. 7, or any aspect related to it.

The one or more processors 920 include circuitry configured to implement (e.g., execute) the code stored in the computer-readable medium/memory 930, including circuitry for receiving 921 and circuitry for performing 922. Processing with circuitry 921-922 may cause the communications device 900 to perform the method 700 described with respect to FIG. 7, or any aspect related to it.

Various components of the communications device 900 may provide means for performing the method 700 described with respect to FIG. 7, or any aspect related to it. For example, means for transmitting, sending or outputting for transmission may include the transceivers 354 and/or antenna(s) 352 of the UE 104 illustrated in FIG. 3 and/or transceiver 908 and antenna 910 of the communications device 900 in FIG. 9. Means for receiving or obtaining may include the transceivers 354 and/or antenna(s) 352 of the UE 104 illustrated in FIG. 3 and/or transceiver 908 and antenna 910 of the communications device 900 in FIG. 9.

FIG. 10 depicts aspects of an example communications device. In some aspects, communications device 1000 is a network entity, such as BS 102 of FIGS. 1 and 3, or a disaggregated base station as discussed with respect to FIG. 2.

The communications device 1000 includes a processing system 1002 coupled to a transceiver 1008 (e.g., a transmitter and/or a receiver) and/or a network interface 1012. The transceiver 1008 is configured to transmit and receive signals for the communications device 1000 via an antenna 1010, such as the various signals as described herein. The network interface 1012 is configured to obtain and send signals for the communications device 1000 via communications link(s), such as a backhaul link, midhaul link, and/or fronthaul link as described herein, such as with respect to FIG. 2. The processing system 1002 may be configured to perform processing functions for the communications device 1000, including processing signals received and/or to be transmitted by the communications device 1000.

The processing system 1002 includes one or more processors 1020. In various aspects, one or more processors 1020 may be representative of one or more of receive processor 338, transmit processor 320, TX MIMO processor 330, and/or controller/processor 340, as described with respect to FIG. 3. The one or more processors 1020 are coupled to a computer-readable medium/memory 1030 via a bus 1006. In certain aspects, the computer-readable medium/memory 1030 is configured to store instructions (e.g., computer-executable code) that when executed by the one or more processors 1020, cause the one or more processors 1020 to perform the method 800 described with respect to FIG. 8, or any aspect related to it. Note that reference to a processor of communications device 1000 performing a function may include one or more processors of communications device 1000 performing that function.

In the depicted example, the computer-readable medium/memory 1030 stores code (e.g., executable instructions) for obtaining 1031 and code for outputting 1032. Processing of the code 1031-1032 may cause the communications device 1000 to perform the method 800 described with respect to FIG. 8, or any aspect related to it.

The one or more processors 1020 include circuitry configured to implement (e.g., execute) the code stored in the computer-readable medium/memory 1030, including circuitry for obtaining 1021 and circuitry for outputting 1022. Processing with circuitry 1021-1022 may cause the communications device 1000 to perform the method 800 as described with respect to FIG. 8, or any aspect related to it.

Various components of the communications device 1000 may provide means for performing the method 800 as described with respect to FIG. 8, or any aspect related to it. Means for transmitting, sending or outputting for transmission may include the transceivers 332 and/or antenna(s) 334 of the BS 102 illustrated in FIG. 3 and/or transceiver 1008 and antenna 1010 of the communications device 1000 in FIG. 10. Means for receiving or obtaining may include the transceivers 332 and/or antenna(s) 334 of the BS 102 illustrated in FIG. 3 and/or transceiver 1008 and antenna 1010 of the communications device 1000 in FIG. 10.

### Example Clauses

Implementation examples are described in the following numbered clauses:

Clause 1: A method for wireless communications by a user equipment (UE), comprising: receiving system information including information for cell selection, cell reselection, or a combination thereof, wherein the system information comprises at least first system information associated with a first one or more capabilities and second system information associated with a second one or more capabilities; performing a measurement of one or more signals from one or more cells; and performing cell selection, cell reselection, or both based at least in part on the system information, the measurement of the one or more signals, and one or more capabilities of the UE.

Clause 2: The method of clause 1, wherein performing the cell selection, cell reselection, or both comprises: prioritizing selection of a cell that supports one or more of the capabilities of the UE over a cell that does not support the one or more capabilities of the UE.

Clause 3: The method of any one or more of clauses 1-2, wherein the system information is received in one or more system information blocks (SIB s).

Clause 4: The method of any one or more of clauses 1-3, wherein the second one or more capabilities are different than the first one or more capabilities.

Clause 5: The method of clause 4, wherein the second one or more capabilities comprises lack of support for the first one or more capabilities.

Clause 6: The method of any one or more of clauses 1-5, wherein performing the cell selection, cell reselection, or both comprises: performing the cell selection, the cell reselection, or both using the first system information when the UE supports the first one or more capabilities; and performing the cell selection, the cell reselection, or both using the second system information when the UE supports the second one or more capabilities.

Clause 7: The method of any one or more of clauses 1-6, wherein the system information comprises one or more thresholds for cell selection, one or more threshold for reselection, one or more thresholds for performing inter-cell measurements, or a combination thereof.

Clause 8: The method of clause 7, wherein the system information further comprises one or more offsets associated with the one or more thresholds for cell selection, the one or more thresholds for reselection, the one or more thresholds for performing inter-cell measurements, or a combination thereof, based on the one or more capabilities.

Clause 9: The method of any one or more of clauses 7-8, wherein the system information further comprises one or more threshold scaling factors associated with the one or more thresholds for cell selection, one or more thresholds for reselection, one or more thresholds for performing inter-cell measurements, or a combination thereof, based on the one or more capabilities.

Clause 10: The method of any one or more of clauses 7-9, wherein the system information further comprises one or more time duration thresholds associated with the one or more thresholds for cell selection, one or more thresholds for reselection, one or more thresholds for performing inter-cell measurements, or a combination thereof, based on the one or more capabilities.

Clause 11: The method of any one or more of clauses 7-10, wherein the one or more thresholds for cell selection comprises: a cell selection received signal quality threshold (Srxlev); and a cell selection quality value (Squal).

Clause 12: The method of any one or more of clauses 1-11, wherein the system information further includes: a first set of parameters comprising first one or more minimum received quality level parameters, one or more minimum received quality offset parameters, one or more power compensation parameters, one or more signal quality temporary offset parameters, one or more signal quality minimum parameters, one or more cell specific signal quality minimum offset parameters, or a combination thereof, associated with the first one or more capabilities; and a second set of parameters comprising second one or more minimum received quality level parameters, one or more minimum received quality offset parameters, one or more power compensation parameters, one or more signal quality temporary offset parameters, one or more signal quality minimum parameters, one or more cell specific signal quality minimum offset parameters, or a combination thereof, associated with the second one or more capabilities.

Clause 13: The method of any one or more of clauses 1-12, wherein: the first one or more capabilities comprises a first plurality of capabilities corresponding to a first feature group; and the second one or more capabilities comprises a second plurality of capabilities corresponding to a second feature group.

Clause 14: The method of any one or more of clauses 1-13, wherein: the system information further includes cell barring information based on the one or more capabilities; and the cell barring information indicates one or more cells as unavailable for cell selection and cell reselection, one or more cells as available for cell selection and cell reselection, or a combination thereof.

Clause 15: The method of any one or more of clauses 1-14, wherein the one or more capabilities comprises an integrated access and backhaul (IAB) mobile termination (MT) capability of the UE or a reduced capability (RedCap) capability of the UE.

Clause 16: The method any one or more of clauses 1-15, wherein the one or more capabilities comprises a capability of the UE to report one or more worst beams, a capability of the UE to perform cross link interference (CLI) measurement, a capability of the UE for full-duplex (FD) communication, a capability of the UE to dynamically activate and deactivate uplink transmissions with energy saving patterns, a capability of the UE to report traffic predictions, or a combination thereof.

Clause 17: The method of any one or more of clauses 1-16, wherein: the system information includes cell capability information of the one or more cells; and performing the cell selection, cell reselection, or both comprises performing the cell selection, the cell reselection, or both based on the cell capability information.

Clause 18: The method of clause 17, wherein: the cell capability information comprises network energy saving state information.

Clause 19: The method of clause 18, wherein the network energy saving state information indicates at least one of: a normal active state in which any UE is permitted to access the cell; a power saving state in which the cell is not preferred for high performance UEs; a deep power saving state in which a normal UE should not attempt to camp on the cell; or an inactive state in which the cell is not available for access until the cell wakes up.

Clause 20: The method of any one or more of clauses 1-19, wherein the UE is in a radio resource control (RRC) idle mode or an RRC inactive mode.

Clause 21: The method of any one or more of clauses 1-20, wherein: the system information further indicates one or more whitelisted cells, one or more blacklisted cells, or a combination thereof, based on the one or more capabilities: the whitelisted cells indicate cells for performing measurements; and the blacklisted cells indicate to skip for performing measurements.

Clause 22: A method for wireless communications by a network entity, comprising: obtaining information indicating one or more capabilities including one or more capabilities of the network entity, one or more cell capabilities, one or more user equipment (UE) capabilities, or a combination thereof; and output system information including information for cell selection, cell reselection, or a combination thereof, wherein the system information is based at least in part on the one or more capabilities.

Clause 23: The method of clause 22, wherein the system information is output for transmission in one or more system information blocks (SIBs).

Clause 24: The method of any one or more of clauses 22-23, wherein the system information comprises first system information for first one or more capabilities and second system information for second one or more capabilities, and wherein second one or more capabilities are different than the first one or more capabilities.

Clause 25: The method of clause 24, wherein the second one or more capabilities comprises lack of support for the first one or more capabilities.

Clause 26: The method of any one or more of clauses 22-25, wherein the system information comprises: one or more thresholds for cell selection, one or more threshold for reselection, one or more thresholds for performing inter-cell measurements, or a combination thereof.

Clause 27: The method of clause 26, wherein the system information further comprises one or more offsets associated with the one or more thresholds for cell selection, the one or more thresholds for reselection, the one or more thresholds for performing inter-cell measurements, or a combination thereof, based on the one or more capabilities.

Clause 28: The method of any one or more of clauses 26-27, wherein the system information further comprises one or more threshold scaling factors associated with the one or more thresholds for cell selection, one or more thresholds for reselection, one or more thresholds for performing inter-cell measurements, or a combination thereof, based on the one or more capabilities.

Clause 29: The method of any one or more of clauses 26-28, wherein the system information further comprises one or more time duration thresholds associated with the one or more thresholds for cell selection, one or more thresholds for reselection, one or more thresholds for performing inter-cell measurements, or a combination thereof, based on the one or more capabilities.

Clause 30: The method of any one or more of clauses 26-29, wherein the one or more thresholds for cell selection comprises: a cell selection received signal quality threshold (Srxlev); and a cell selection quality value (Squal).

Clause 31: The method of any one or more of clauses 22-30, wherein the system information further includes: a first set of parameters comprising first one or more minimum received quality level parameters, one or more minimum received quality offset parameters, one or more power compensation parameters, one or more signal quality temporary offset parameters, one or more signal quality minimum parameters, one or more cell specific signal quality minimum offset parameters, or a combination thereof, associated with the first one or more capabilities; and a second set of parameters comprising second one or more minimum received quality level parameters, one or more minimum received quality offset parameters, one or more power compensation parameters, one or more signal quality temporary offset parameters, one or more signal quality minimum parameters, one or more cell specific signal quality minimum offset parameters, or a combination thereof, associated with the second one or more capabilities.

Clause 32: The method of any one or more of clauses 22-31, wherein: the first one or more capabilities comprises a first plurality of capabilities corresponding to a first feature group; and the second one or more capabilities comprises a second plurality of capabilities corresponding to a second feature group.

Clause 33: The method of any one or more of clauses 22-32, wherein: the system information further includes cell barring information based on the one or more capabilities; and the cell barring information indicates one or more cells as unavailable for cell selection and cell reselection, one or more cells as available for cell selection and cell reselection, or a combination thereof.

Clause 34: The method of any one or more of clauses 22-33, wherein the one or more capabilities comprises an integrated access and backhaul (IAB) mobile termination (MT) capability or a reduced capability (RedCap).

Clause 35: The method of any one or more of clauses 22-34, wherein the one or more capabilities comprises a capability to report one or more worst beams, a capability to perform cross link interference (CLI) measurement, a capability for full-duplex (FD) communication, a capability to dynamically activate and deactivate uplink transmissions with energy saving patterns, a capability to report traffic predictions, or a combination thereof.

Clause 36: The method of any one or more of clauses 22-35, wherein the system information includes cell capability information of the one or more cells.

Clause 37: The method of clause 36, wherein the cell capability information comprises network energy saving state information.

Clause 38: The method of clause 37, wherein the network energy saving state information indicates at least one of: a normal active state in which any user equipment (UE) is permitted to access the cell; a power saving state in which the cell is not preferred for high performance UEs; a deep power saving state in which a normal UE should not attempt to camp on the cell; or an inactive state in which the cell is not available for access until the cell wakes up.

Clause 39: The method of any one or more of clauses 22-38, wherein: the system information further indicates one or more whitelisted cells, one or more blacklisted cells, or a combination thereof, based on the one or more capabilities: the whitelisted cells indicate cells for performing measurements; and the blacklisted cells indicate to skip for performing measurements.

Clause 40: An apparatus, comprising: a memory comprising executable instructions; and a processor configured to execute the executable instructions and cause the apparatus to perform a method in accordance with any one of Clauses 1-39.

Clause 41: An apparatus, comprising means for performing a method in accordance with any one of Clauses 1-39.

Clause 42: A non-transitory computer-readable medium comprising executable instructions that, when executed by a processor of an apparatus, cause the apparatus to perform a method in accordance with any one of Clauses 1-39.

Clause 43: A computer program product embodied on a computer-readable storage medium comprising code for performing a method in accordance with any one of Clauses 1-39.

Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus configured for wireless communications, comprising:
a memory comprising computer-executable instructions; and
a processor configured to execute the computer-executable instructions and cause the apparatus to:
receive system information including information for cell selection, cell reselection, or a combination thereof, wherein the system information comprises at least first system information associated with a first one or more capabilities and second system information associated with a second one or more capabilities;
perform a measurement of one or more signals from one or more cells; and
perform cell selection, cell reselection, or both based at least in part on the system information, the measurement of the one or more signals, and one or more capabilities of the apparatus.

2. The apparatus of claim 1, wherein the processor being configured to cause the apparatus to perform the cell selection, cell reselection, or both comprises the processor being configured to cause the apparatus to:
prioritize selection of a cell that supports one or more of the capabilities of the apparatus over a cell that does not support the one or more capabilities of the apparatus.

3. The apparatus of claim 1, wherein the system information is received in one or more system information blocks (SIBs).

4. The apparatus of claim 1, wherein the second one or more capabilities are different than the first one or more capabilities.

5. The apparatus of claim 4, wherein the second one or more capabilities comprises lack of support for the first one or more capabilities.

6. The apparatus of claim 1, wherein the processor being configured to cause the apparatus to perform the cell selection, cell reselection, or both comprises the processor being configured to cause the apparatus to:
perform the cell selection, the cell reselection, or both using the first system information when the apparatus supports the first one or more capabilities; and
perform the cell selection, the cell reselection, or both using the second system information when the apparatus supports the second one or more capabilities.

7. The apparatus of claim 1, wherein the system information comprises:
one or more thresholds for cell selection, one or more threshold for reselection, one or more thresholds for performing inter-cell measurements, or a combination thereof.

8. The apparatus of claim 7, wherein the system information further comprises one or more offsets associated with the one or more thresholds for cell selection, the one or more thresholds for reselection, the one or more thresholds for performing inter-cell measurements, or a combination thereof, based on the one or more capabilities.

9. The apparatus of claim 7, wherein the system information further comprises one or more threshold scaling factors associated with the one or more thresholds for cell selection, one or more thresholds for reselection, one or more thresholds for performing inter-cell measurements, or a combination thereof, based on the one or more capabilities.

10. The apparatus of claim 7, wherein the system information further comprises one or more time duration thresholds associated with the one or more thresholds for cell selection, one or more thresholds for reselection, one or more thresholds for performing inter-cell measurements, or a combination thereof, based on the one or more capabilities.

11. The apparatus of claim 7, wherein the one or more thresholds for cell selection comprises:
a cell selection received signal quality threshold (Srxlev); and
a cell selection quality value (Squal).

12. The apparatus of claim 1, wherein the system information further includes:
a first set of parameters comprising first one or more minimum received quality level parameters, one or more minimum received quality offset parameters, one or more power compensation parameters, one or more signal quality temporary offset parameters, one or more signal quality minimum parameters, one or more cell specific signal quality minimum offset parameters or a combination thereof, associated with the first one or more capabilities; and
a second set of parameters comprising second one or more minimum received quality level parameters, one or more minimum received quality offset parameters, one or more power compensation parameters, one or more signal quality temporary offset parameters, one or more signal quality minimum parameters, one or more cell specific signal quality minimum offset parameters, or a combination thereof, associated with the second one or more capabilities.

13. The apparatus of claim 1, wherein:
the first one or more capabilities comprises a first plurality of capabilities corresponding to a first feature group; and
the second one or more capabilities comprises a second plurality of capabilities corresponding to a second feature group.

14. The apparatus of claim 1, wherein:
the system information further includes cell barring information based on the one or more capabilities; and
the cell barring information indicates one or more cells as unavailable for cell selection and cell reselection, one or more cells as available for cell selection and cell reselection, or a combination thereof.

15. The apparatus of claim 1, wherein the one or more capabilities comprises an integrated access and backhaul (IAB) mobile termination (MT) capability of the apparatus or a reduced capability (RedCap) capability of the apparatus.

16. The apparatus of claim 1, wherein the one or more capabilities comprises a capability of the apparatus to report one or more worst beams, a capability of the apparatus to perform cross link interference (CLI) measurement, a capability of the apparatus for full-duplex (FD) communication, a capability of the apparatus to dynamically activate and deactivate uplink transmissions with energy saving patterns, a capability of the apparatus to report traffic predictions, or a combination thereof.

17. The apparatus of claim 1, wherein:
the system information includes cell capability information of the one or more cells; and
the processor being configured to cause the apparatus to perform the cell selection, cell reselection, or both comprises the processor being configured to cause the apparatus to perform the cell selection, the cell reselection, or both based on the cell capability information.

18. The apparatus of claim 17, wherein: the cell capability information comprises network energy saving state information.

19. The apparatus of claim 18, wherein the network energy saving state information indicates at least one of:
a normal active state in which any user equipment (UE) is permitted to access a cell;
a power saving state in which the cell is not preferred for high performance UEs;
a deep power saving state in which a normal UE should not attempt to camp on the cell; or
an inactive state in which the cell is not available for access until the cell wakes up.

20. The apparatus of claim 1, wherein the apparatus comprises a user equipment (UE) in a radio resource control (RRC) idle mode or an RRC inactive mode.

21. The apparatus of claim 1, wherein:
the system information further indicates one or more whitelisted cells, one or more blacklisted cells, or a combination thereof, based on the one or more capabilities:
the whitelisted cells indicate cells for performing measurements; and
the blacklisted cells indicate to skip for performing measurements.

22. An apparatus configured for wireless communications, comprising:
a memory comprising computer-executable instructions; and
a processor configured to execute the computer-executable instructions and cause the apparatus to:
obtain information indicating one or more capabilities including one or more capabilities of the apparatus, one or more cell capabilities, one or more user equipment (UE) capabilities, or a combination thereof; and
output system information including information for cell selection, cell reselection, or a combination thereof, wherein the system information is based at least in part on the one or more capabilities.

23. The apparatus of claim 22, wherein the system information is output for transmission in one or more system information blocks (SIBs).

24. The apparatus of claim 22, wherein the system information comprises first system information for first one or more capabilities and second system information for second one or more capabilities, and wherein second one or more capabilities are different than the first one or more capabilities.

25. The apparatus of claim 24, wherein the second one or more capabilities comprises lack of support for the first one or more capabilities.

26. The apparatus of claim 24, wherein the system information comprises:
one or more thresholds for cell selection, one or more threshold for reselection, one or more thresholds for performing inter-cell measurements, or a combination thereof.

27. The apparatus of claim 26, wherein the system information further comprises one or more offsets associated with the one or more thresholds for cell selection, the one or more thresholds for reselection, the one or more thresholds for performing inter-cell measurements, or a combination thereof, based on the one or more capabilities.

28. The apparatus of claim 26, wherein the system information further comprises one or more threshold scaling factors associated with the one or more thresholds for cell selection, one or more thresholds for reselection, one or more thresholds for performing inter-cell measurements, or a combination thereof, based on the one or more capabilities.

29. A method for wireless communications by a user equipment (UE), comprising:
receiving system information including information for cell selection, cell reselection, or a combination thereof, wherein the system information comprises at least first system information associated with a first one or more capabilities and second system information associated with a second one or more capabilities;
performing a measurement of one or more signals from one or more cells; and
performing cell selection, cell reselection, or both based at least in part on the system information, the measurement of the one or more signals, and one or more capabilities of the UE.

30. A method for wireless communications by a network entity, comprising:
obtaining information indicating one or more capabilities including one or more capabilities of the network entity, one or more cell capabilities, one or more user equipment (UE) capabilities, or a combination thereof; and
outputting system information, wherein the system information includes information for cell selection, information for cell reselection, or a combination thereof, and wherein the system information is based at least in part on the one or more capabilities.
